(19) United States
(12) Patent Application Publication
(10) Pub. No.: US 2014/0153372 A1
(43) Pub. Date: Jun. 5, 2014

(54) OSCILLATING MASS PIVOTED ON THE EXTERIOR OF A TIMEPIECE MOVEMENT, TIMEPIECE MOVEMENT FITTED WITH SUCH AN OSCILLATING MASS AND TIMEPIECE COMPRISING SUCH AN OSCILLATING MASS

(71) Applicants: Carole Kasapi, La chaux-de-Fonds (CH); Laurent Dechaumont, La chaux-de-Fonds (CH)

(72) Inventors: Carole Kasapi, La chaux-de-Fonds (CH); Laurent Dechaumont, La chaux-de-Fonds (CH)

(73) Assignee: Cartier Creation Studio SA, Geneva (CH)

(21) Appl. No.: 14/234,436

(22) PCT Filed: Jul. 12, 2012
(86) PCT No.: PCT/IB2012/001364

§ 371 Date: Jan. 23, 2014

(30) Foreign Application Priority Data
Jul. 28, 2011 (EP) 11006204.9

(51) Int. Cl. G04B 5/02

(52) U.S. Cl. CPC G04B 5/02
USPC 368/208

(57) ABSTRACT

The oscillating mass able to be fixed to a frame (1) pivoted on the exterior of a timepiece movement has toothing kinematically connected to the ratchet of a barrel of the timepiece movement. This oscillating mass has, on the one hand, a mount (4) which is annular or is in the form of an annular sector and is able to be fixed to the frame (1) and, on the other hand, a central part (7) located mainly or exclusively in one half of the surface delimited by the mount (4).

The present invention relates to pivoting or oscillating automatic winding masses pivoted on the exterior of a timepiece movement, as well as to automatic winding timepiece movements and timepieces fitted with such an oscillating or pivoting mass.

An oscillating mass of this type is known from document DE 10 2009 005 690 which has a circular ring, the inner edge of which is provided with toothing intended to be kinematically connected to the ratchet of a barrel. The upper surface of this circular ring bears the winding mass itself which is in the form of a crown sector having an angular span of preferably 180°.

Unless the height or diameter of a movement fitted with such an automatic winding mass pivoted on the exterior of the movement is considerably increased, the power and efficiency of the automatic winding system are low, the dimensions and thus the weight of the mass being greatly reduced.

An oscillating mass intended to be pivoted by a ball bearing on the exterior of a timepiece movement is also known from document CH 458213. This mass also has the form of an annular sector having an angular extent of the order of 180°. However, this embodiment has the same disadvantages as those stated above in relation to the embodiment described in document DE 10 2009 005 690.

The aim of the present invention is to enable the formation of an automatic winding timepiece movement, the oscillating mass of which, pivoted on the exterior of the movement, can have a greater weight for dimensions given by the diameter and height of the timepiece movement so as to achieve an automatic winding mechanism which is more powerful and effective than the known devices.

Another aim of the present invention is to provide, by way of the shape of the oscillating mass pivoted on the exterior of a timepiece movement, such a movement with a visual and aesthetic effect which is new, fun and attractive.

The object of the present invention is an oscillating mass able to be fixed to a frame pivoted on the exterior of a timepiece movement and having toothing kinematically connected to the ratchet of a barrel of said timepiece movement, characterised in that the oscillating mass has, on the one hand, a mount which is annular or is in the form of an annular sector and is able to be fixed to said frame and, on the other hand, a central part located mainly or exclusively in one half of the surface delimited by said mount.

Still another object of the present invention is an automatic winding timepiece movement having an oscillating mass fixed to a frame pivoted on the exterior of the timepiece movement, this frame having toothing meshing with a kinematic link connecting it to the ratchet of a barrel of the timepiece movement; characterised in that the oscillating mass has, on the one hand, a mount which is annular or is in the form of an annular sector and is able to be fixed to said frame and, on the other hand, a central part located mainly or exclusively in one half of the surface delimited by said mount.

Still another object of the present invention is an automatic winding timepiece, in particular a wristwatch, comprising a timepiece movement and hands, characterised in that the movement has an automatic winding mechanism, the oscillating mass of which is formed in accordance with any one of the preceding claims, and in that the central part of the oscillating mass moves on the same side of the movement as the hands but does not thereby interfere therewith.

The accompanying drawing illustrates schematically and by way of example an oscillating mass intended to be pivoted on the exterior of a timepiece movement, and illustrates partially a timepiece movement fitted with such an oscillating mass.

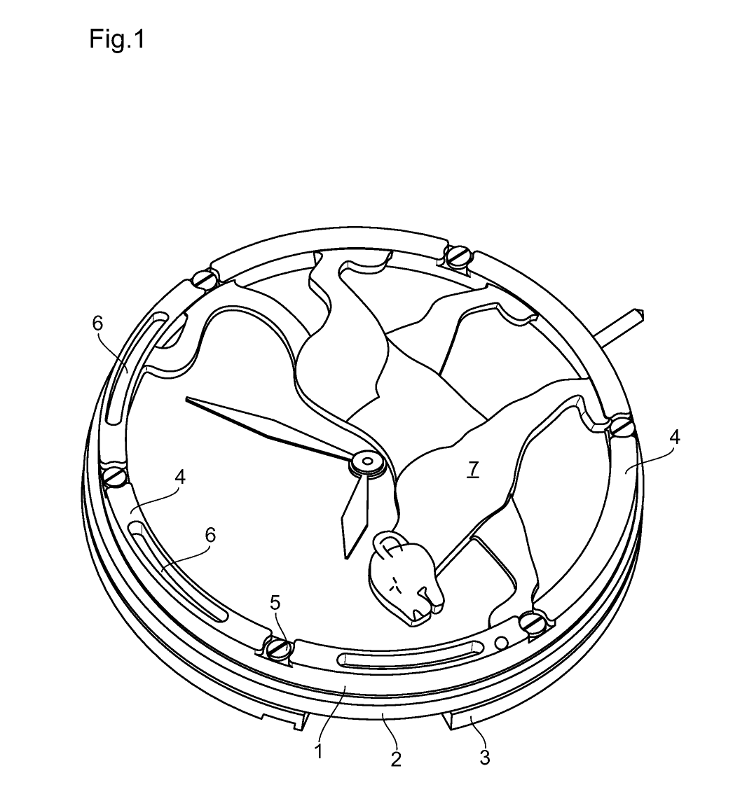

FIG. 1 is a perspective view of the oscillating mass pivoted on the exterior of a timepiece movement by a ball bearing.

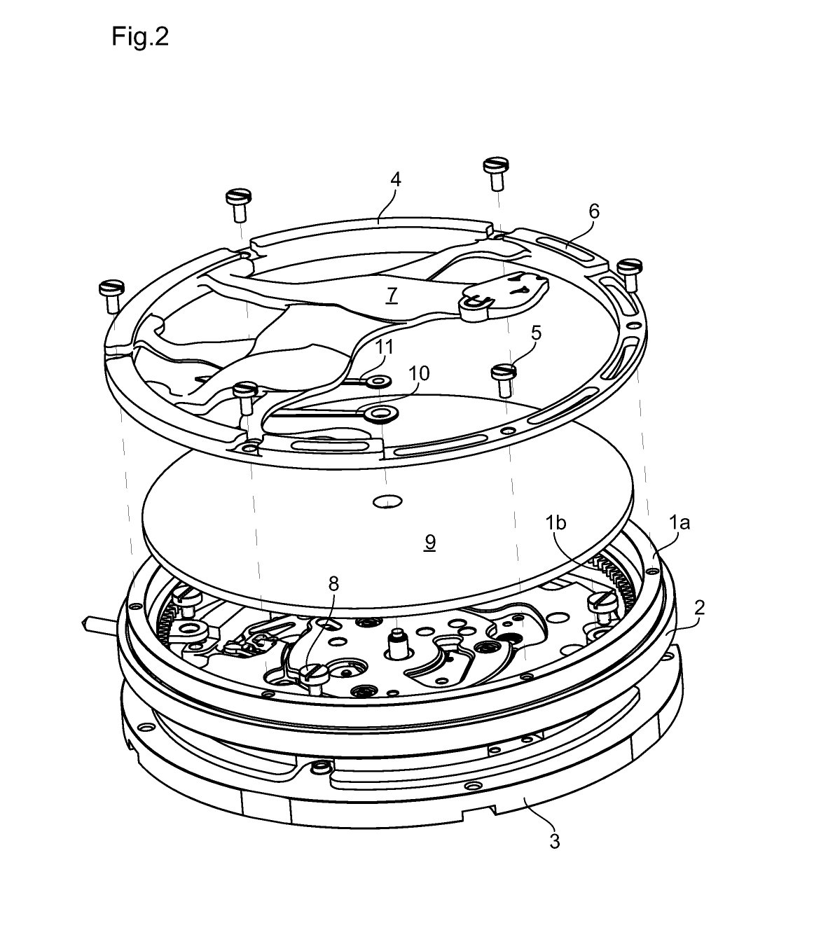

FIG. 2 is a partial, exploded view of a timepiece movement fitted with an oscillating mass pivoted on the exterior of said movement.

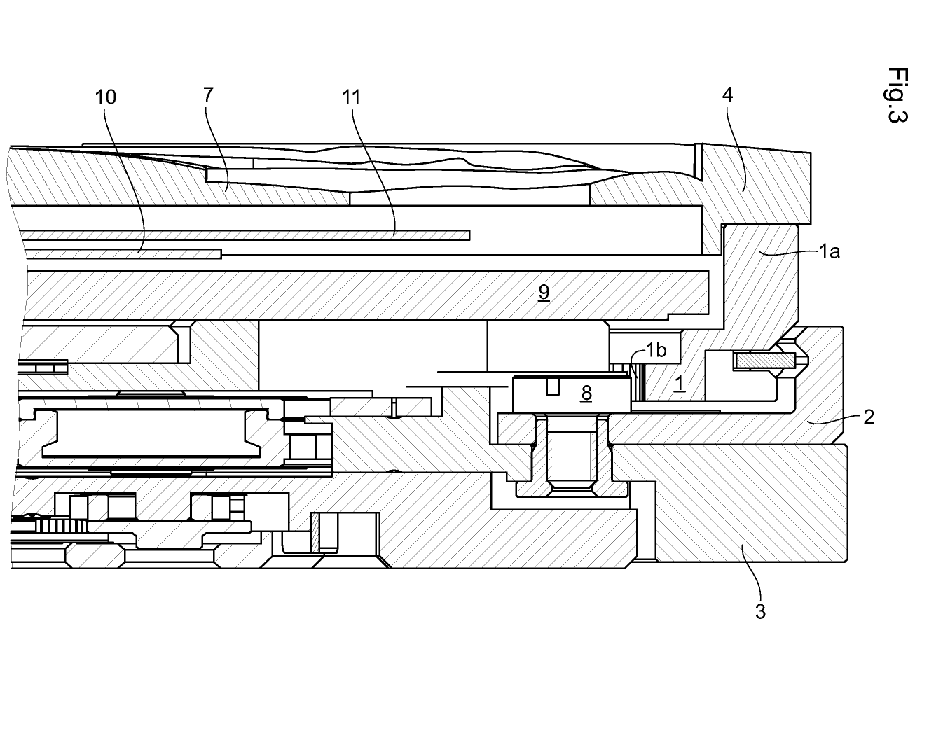

FIG. 3 is a partial, cross-sectional view of a timepiece movement fitted with an oscillating mass pivoted on the exterior of said movement.

FIG. 1 is a perspective view of one embodiment of an oscillating mass in accordance with the invention fixed to the inner frame of a ball bearing, the outer frame 2 of which is fixed to the peripheral part of the plate 3 of a timepiece movement, in particular a wristwatch.

This oscillating mass has an annular mount 4 intended to be fixed by screws 5 to the upper part of the inner frame 1 of a ball bearing. In the illustrated embodiment (as can be seen particularly clearly in FIG. 2), the annular mount 4 has a thicker (and thus heavier) part and a thinner (and thus lighter) part and it is also provided with openings 6 in and along the thinner and lighter part. In this manner, the weight of the annular mount 4 is not distributed uniformly and the annular mount thus has an unbalance. The effect of the unbalance can also be obtained by other means known to the person skilled in the art—for example by using materials of different weights for the heavier and lighter parts respectively (either instead of or in combination with the means described above).

This oscillating mass also has a central part 7 located mainly or even exclusively in the part of the surface delimited by the heavier part of the annular mount 4. This central part 7 is fixed at one or several points to the heavier part of the annular mount 4. Preferably, the central part 7 is located mainly or exclusively in one half of the surface delimited by the annular mount 4. This central part 7 of the oscillating mass can, of course, also be made in one piece with the annular outer mount 4.

In this manner, the oscillating mass can have a large unbalance (which, preferably, is added to the unbalance of the mount 4) corresponding at least to the weight of the central part 7 of the oscillating mass which provides increased power and efficiency for the oscillating mass for winding an automatic winding mechanism of a timepiece movement.

The central part of the oscillating mass may have any shape but is preferably in the shape of a figure, such as a panther in the illustrated embodiment.

In such an oscillating mass, the unbalance is much greater than for an oscillating mass which is annular or in the form of an annular sector as is currently known. Preferably, the central part 7 of the mass takes up, at the most, half of the surface delimited by the annular mount 4 of the oscillating mass but for some desired shapes of the central part 7 it could extend into the other half so long as its unbalance effect is not adversely affected to a significant extent.

In variations, the mount of the mass can comprise an annular sector having an angular extent less than 360° (e.g., of the order of 180°. The weight of such a mount can be distributed uniformly or it can be lighter towards its ends. The central part of the mass can be fixed to or connected to this mount as described above.

FIGS. 2 and 3 illustrate schematically and partially a timepiece movement fitted with an oscillating mass as described above.

The outer frame 2 of the ball bearing is fixed to the plate 3 of the timepiece movement using screws 8. The inner frame 1 of the ball bearing has a cylindrical upper part la surrounding the dial 9 of the timepiece movement, the upper surface thereof being located in a plane in parallel with the dial 9 but above the hands 10, 11 of the time display of the timepiece movement.

Preferably, the oscillating mass 4, 7 is fixed by screws 5 to the cylindrical part la of the inner frame of the ball bearing such that the central part 7 of the oscillating mass moves above the hands of the timepiece movement. In this manner, the central mass 7 of the oscillating mass is such that it does not interfere with the spindle(s) of the hands of the movement but moves above the dial and hands.

The shape of the central part 7 of the oscillating mass is preferably such that, regardless of its angular position with respect to the movement during operation thereof, the spindle(s) of the hands of the time display of said movement is(are) always out of the sweeping area of this central part 7 and thus of the oscillating mass 4, 7.

Thus, in one alternative embodiment, the plane in which the oscillating mass 4, 7 moves can be in parallel with the dial 9 but located between said dial 9 and the hands 10, 11. In such an embodiment, the hands 10, 11 are always fully visible for the user of the watch having such an oscillating mass for its automatic winding mechanism.

Of course, the dial can also be omitted, as in a skeleton watch, and in this case the central part of the mass would be located between the plate and the hands 10, 11 in this variation.

The central part (7) of the oscillating mass moves on the same side of the movement as the hands whilst not interfering therewith.

A watch having a movement fitted with an oscillating mass in accordance with the present invention allows efficient and powerful winding of its barrel on the one hand and has completely new, original, fun and attractive aesthetics on the other hand.

As can be seen in FIGS. 2 and 3, the lower part of the inner ring 1 of the ball bearing has toothing lb meshing with a kinematic link connecting it to the ratchet of a barrel of the movement in a manner well known to the person skilled in the art.

1. Automatic winding timepiece movement having an oscillating mass (4, 6, 7) fixed to a frame (1) pivoted on the exterior of the timepiece movement, this frame (1) having toothing (1b) meshing with a kinematic link connecting it to the ratchet of a barrel of the timepiece movement; characterised in that the oscillating mass has, on the one hand, a mount (4) which is annular or is in the form of an annular sector and is able to be fixed to said frame (1) and, on the other hand, a central part (7) located mainly or exclusively in one half of the surface delimited by said mount (4).

2. Oscillating mass able to be fixed to a frame (1) pivoted on the exterior of a timepiece movement and having toothing kinematically connected to the ratchet of a barrel of said timepiece movement, characterised in that the oscillating mass has, on the one hand, a mount (4) which is annular or is in the form of an annular sector and is able to be fixed to said frame (1) and, on the other hand, a central part (7) located mainly or exclusively in one half of the surface delimited by said mount (4).

3. Oscillating mass as claimed in claim 2, characterised in that the annular mount (4) also forms an unbalance and comprises a heavier part and a lighter part, the central part (7) being fixed at one or several points to the heavier part of the annular mount (4).

4. Oscillating mass as claimed in claim 3, characterised in that the annular mount has openings (6) distributed over its lighter part.

5. Oscillating mass as claimed in claim 2, characterised in that the central part (7) is made in one piece with the mount (4).

6. Oscillating mass as claimed in claim 2, characterised in that the central part (7) represents a figure.

7. Automatic winding timepiece, in particular a wristwatch, comprising a timepiece movement and hands (10, 11), characterised in that the movement has an automatic winding mechanism, the oscillating mass of which is formed in accordance with claim 2, and in that the central part (7) of the oscillating mass moves on the same side of the movement as the hands (10, 11) but does not thereby interfere therewith.

8. Timepiece as claimed in claim 7, characterised in that the oscillating mass (4, 7) is pivoted on the exterior of the movement via a ball bearing (1, 2).

9. Timepiece as claimed in claim 8, characterised in that the oscillating mass (4, 7) is fixed to the inner frame (1) of the ball bearing whilst the outer frame (2) of this ball bearing is fixed to the periphery of a plate (3) of the movement.

10. Timepiece as claimed in claim 8, characterised in that the inner frame (1a) of the ball bearing has inner toothing driving, via a kinematic link, the ratchet of a barrel of the movement.

11. Timepiece as claimed in claim 7, characterised in that the plane in which the central part (7) of the oscillating mass (4, 7) moves is in parallel with the dial (9) of the timepiece or with the plate (3) of the movement if the timepiece does not comprise a dial, the hands (10, 11) being located between this movement plane of the central part (7) of the oscillating mass and the dial (9) or the plate.

12. Timepiece as claimed in claim 7, characterised in that the plane in which the central part (7) of the oscillating mass (4, 7) moves is in parallel with the dial (9) of the timepiece or with the plate (3) of the movement if the timepiece does not comprise a dial, this movement plane of the central part (7) of the oscillating mass being located between the dial (9) or the plate and the hands (10, 11);
and in that the spindle(s) of these hands is(are) located out of the sweeping area of the central part (7) of the oscillating mass.

13. Oscillating mass as claimed in claim 3, characterised in that the central part (7) is made in one piece with the mount (4).

14. Oscillating mass as claimed in claim 3, characterised in that the central part (7) represents a figure.

15. Automatic winding timepiece, in particular a wristwatch, comprising a timepiece movement and hands (10, 11), characterised in that the movement has an automatic winding mechanism, the oscillating mass of which is formed in accordance with claim 3, and in that the central part (7) of the oscillating mass moves on the same side of the movement as the hands (10, 11) but does not thereby interfere therewith.

16. Timepiece as claimed in claim 9, characterised in that the inner frame (1a) of the ball bearing has inner toothing driving, via a kinematic link, the ratchet of a barrel of the movement.
